(19) United States
(12) Patent Application Publication
(10) Pub. No.: US 2015/0165277 A1
(43) Pub. Date: Jun. 18, 2015

(54) SYSTEM AND METHOD FOR MAKING GOLF BALLS

(71) Applicant: NIKE, Inc., Beaverton, OR (US)

(72) Inventors: Takahisa Ono, Fujisawa (JP); Nicholas Yontz, Portland, OR (US)

(73) Assignee: NIKE, Inc., Beaverton, OR (US)

(21) Appl. No.: 14/632,571

(22) Filed: Feb. 26, 2015

Related U.S. Application Data
(63) Continuation-in-part of application No. 13/403,807, filed on Feb. 23, 2012, now Pat. No. 8,980,156.

(51) Int. Cl. A63B 45/00; G05B 19/18; B23K 26/40; B23K 26/08; B23K 26/36

(52) U.S. Cl. CPC A63B 45/00; B23K 26/08; B23K 26/365; B23K 26/4025; G05B 19/182; G05B 2219/45041

(57) ABSTRACT

A method includes providing a golf ball having a core and a cover layer surrounding the core, and receiving a set of user input criteria via a user interface. The method includes generating a customized feature request signal using the received set of user input criteria, wherein the customized feature request corresponds to a custom surface feature of the cover layer. Material is laser cut from a surface of the cover layer using a laser head of a laser cutting machine in response to the customized feature request signal to thereby form the custom surface feature on the cover layer. A system includes a laser head, computer numerical controller which controls the laser head, and a user interface in communication with the controller. The user interface executes the method noted above to thereby form the custom surface feature on the cover layer.

### CROSS REFERENCE TO RELATED APPLICATIONS

This application is a continuation-in-part of and claims the benefit of priority from U.S. patent application Ser. No. 13/403,807, filed Feb. 23, 2012, which is hereby incorporated by reference in its entirety.

### TECHNICAL FIELD

The present disclosure pertains to a system and method for making a golf ball.

### BACKGROUND

The game of golf is an increasingly popular sport at both amateur and professional levels. A wide range of technologies pertain to the manufacture and design of golf balls. For instance, a method of manufacturing golf balls involves forming dimples on the balls by placing the balls into hemispherical molds having protrusions corresponding to dimples, injecting cover material inside the molds, and applying heat and pressure to the ball. This method applies a coating and forms dimples on the surface of the golf ball. While such a method works well, it requires a mold to be made. Accordingly, making golf balls with different dimple patterns can be time consuming. It would be advantageous to be able to make dimples on the surface of a golf ball without using a mold, and to be able to adjust or customize existing dimples on golf balls.

### SUMMARY

The present disclosure provides a method of making a multi-layered article such as a golf ball. The method may include providing a base multi-layered article, e.g., a stock golf ball, and laser cutting material from an outer layer of the base article in a predetermined pattern. The predetermined pattern may include a dimple pattern and/or a textured pattern. The multi-layered article may be secured to a workpiece holder, and a computer numerical controller may be programmed to cause a laser cutting system to remove material from the outer layer. Laser cutting of material may include programming a computer numerical controller to move the article relative to a laser head as the laser head cuts material from the outer layer. The computer numerical controller may command movement of the laser head relative to the article as the laser head cuts material from the outer layer. Laser cutting material from the outer layer may also include moving the golf ball relative to the laser head as the laser head cuts material from the outer layer.

The present disclosure also provides a method of making a golf ball in particular. The method may include forming a golf ball core, forming a golf ball cover surrounding the golf ball core, and laser cutting material from an outer layer of the golf ball cover in a predetermined pattern, i.e., a coating on the cover and possibly part of the cover itself. Forming a golf ball cover surrounding the golf ball core may include placing the golf ball core between at least two mold chambers, pressing the at least two mold chambers together, and injecting a golf ball cover material into the mold chambers. The predetermined pattern may include a dimple pattern. The predetermined pattern may include a textured pattern. Laser cutting material from the surface of the base golf ball may include programming a computer numerical controller to move the base golf ball relative to a laser head as the laser head cuts material from the surface of the base golf ball.

A system is also provided for making a golf ball. The system may include a laser head configured to emit a laser beam and to move in at least one direction, a workpiece holder configured to hold and move a golf ball in at least one direction, and a computer numerical controller configured to control movement between the laser head and the workpiece. The laser head may be configured to move in three axial directions. The workpiece holder may be configured to pivot in at least two directions. The workpiece holder may include a workpiece table having a holding portion configured to hold a golf ball. The laser head may include a yttrium lithium fluoride laser head. The system may include a user interface configured to enable a user to control the laser head.

A method is disclosed that enables customization of a stock golf ball, e.g., prior to or after a point of sale. The method according to an example embodiment includes providing a stock golf ball having a core and a cover layer surrounding the core, with the cover layer having a coating. The method includes receiving a set of user input criteria via a user interface, for instance a web-based or application-based computer device in communication with another portion of the user interface or another controller as set forth herein. The method further includes generating a customized feature request via the user interface using, or in response to, the received set of user input criteria. The customized feature request corresponds to a custom surface feature of the coating/cover layer, such as a custom dimple depth and/or shape, and/or a custom surface roughness or texture on the cover layer. Additionally, the method includes laser cutting material from the coating/cover layer in response to the customized feature request to thereby form the custom surface feature on the golf ball via a laser cutting machine.

An accompanying system includes a laser head, a computer numerical controller, and a user interface. The laser head is operable for laser cutting material from a surface of a stock golf ball, which may include removing part of the coating or the coating with some of the underlying cover layer. The computer numerical controller is in communication with the laser head, and is programmed to control a laser beam generated by the laser head. The user interface, which is in communication with the computer numerical controller, is programmed to receive a set of user input criteria and to generate a customized feature request signal using the received set of user input criteria. The customized feature request corresponds to a custom surface feature of the golf ball. The user interface is also programmed to request, via transmission of via the customized feature request signal to the computer numerical controller, the laser cutting of material from the surface via the laser head. In this manner, the custom surface feature is formed on the stock golf ball, thus producing a custom golf ball.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is an exemplary system for making a golf ball.

FIG. 2 is a perspective view of a laser head and workpiece table usable as part of the system of FIG. 1, as depicted in a first position.

FIG. 3 is a perspective view of the laser head and workpiece table of FIG. 2 in a second position.

FIG. 4 is a side view of the laser head and workpiece table of FIGS. 2 and 3 in a third position.

FIG. 5 is a side view of the laser head and workpiece table of FIGS. 2-4 in a fourth position.

FIG. 6 is a flow chart describing an exemplary method of making a golf ball according to an embodiment.

FIG. 7 is a schematic illustration of an exemplary system suitable for customization of a stock golf ball as described herein.

FIG. 8 is a flow chart describing an example method for customizing a stock golf ball using the system shown in FIG. 7.

### DETAILED DESCRIPTION

A system and method for making golf balls is disclosed. The system may include laser cutting patterns into a golf ball cover layer. For example, dimples and/or textured surfaces may be laser cut into a coating of a golf ball cover layer. During research and development of golf balls, prototype golf balls having various dimple patterns may be tested to determine which dimple patterns yield certain flight characteristics. Typically, golf ball dimples are formed by placing the golf balls into hemispherical mold chambers having protrusions corresponding to dimples. Cover material may be injected inside the mold chambers. Then, heat and pressure may be applied to the ball to mold the outside surface of the golf ball to have a shape corresponding to the inside surface of the mold chamber. Laser cutting dimples into golf balls may expedite the process of making prototype golf balls by eliminating the need for a dimple mold to be made. As a result, laser cutting may provide the ability to make various shapes, sizes, and/or patterns of dimples without the limitations presented by molds. For example, the molding process typically creates a flange, or flashing, in the space between two hemispherical molds pressed together. This flashing must be removed through buffing or other processes and the dimple patterns must be designed around the flashing. These restrictions imposed by the molding process may be eliminated by the disclosed laser cutting process.

Furthermore, laser cutting dimples may provide flexibility in quickly creating different shapes, sizes, and patterns of dimples. Thus, a certain pattern of dimples may be made, tested, and then quickly adjusted. For example, the dimples may be adjusted by cutting away more cover material to make the dimples larger, deeper, and/or in a different shape.

After further testing, the golf ball dimples may be adjusted again multiple times. In some embodiments, laser cutting may be used to add texture to the surface of the golf ball. In some embodiments, laser cutting may add texture to the dimples and/or the and area between the dimples.

The disclosed method may include laser cutting patterns on any type of golf ball. For example, the method may include forming dimples on a golf ball not yet containing any dimples or forming additional dimples on a golf ball already containing dimples. In some embodiments, the method may include customizing a golf ball by adjusting dimples already existing on a golf ball. In some embodiments, the method may include forming dimples on testing golf balls used to test new aerodynamic patterns. For example, testing golf balls may include those described in U.S. patent application Ser. No. 12/958,843, entitled Systems and Methods for Evaluating a Golf Ball Design, applied for by Fitchett and filed on Dec. 2, 2010, the disclosure of which is hereby incorporated by reference in its entirety. In some embodiments, the method may include adding texture to the surface of a golf ball already containing dimples. The base golf ball upon which dimples are to be formed or adjusted may include any type of golf ball. Forming dimples on the base golf ball may be a finishing step. Forming dimples on the golf ball may be used to customize the golf ball. In some embodiments, the base golf ball may include a 1-piece, 2-piece, 3-piece, or 4-piece golf ball. In other embodiments, the base golf ball may include 5 or more layers. All of the layers of the golf ball may be formed by any suitable process. For example, a 2-piece golf ball may be formed by compression molding a golf ball core, placing the golf ball core between at least two mold chambers, pressing the at least two mold chambers together, and injecting a golf ball cover material into the mold chambers around the core. The base golf ball may be made of any suitable type of materials. For example, in some embodiments, the base golf ball may include a 2-piece golf ball having a resin core and a thermoplastic cover. The type of base golf ball and the materials used to form the base golf ball may be selected based on a variety of factors. For example, the type of base golf ball and the materials used to form the base golf ball may be selected based on the desired play characteristics of the base golf ball.

While the exemplary embodiments show the disclosed method being applied to golf balls, the disclosed method may be applied to any type of multi-layered article. The method may include laser cutting patterns on only an outer layer of any type of multi-layered article. In other words, the laser cutting only affects the outer layer of the multi-layered article.

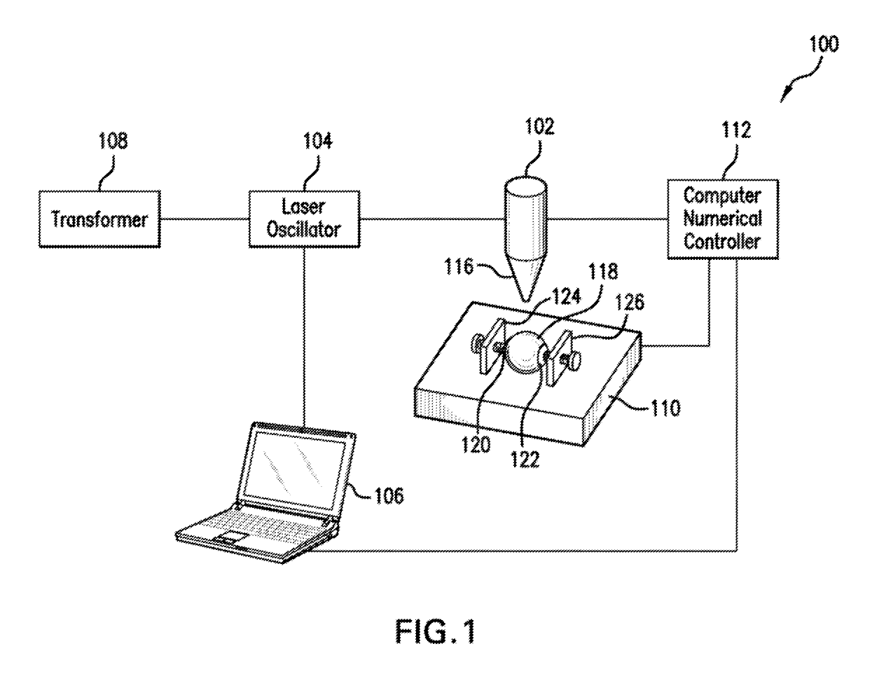

Referring to the drawings, wherein like reference numerals are used to identify like or identical components in the various views, FIG. 1 shows an example embodiment of system for making dimples on the surface of a golf ball. The system may generally include a laser cutting machine 100 having a laser head, a workpiece holder configured to hold and/or move a workpiece, a movement system configured to provide motion between the laser head and the workpiece, and a computer numerical controller configured to control the movement between the laser head and the workpiece.

The laser cutting machine 100 may include any suitable type of laser cutting machine for cutting away golf ball material. For example, the laser cutting machine 100 may include a pulse fiber laser, continuous wave carbon dioxide laser, ultraviolet solid state laser, yttrium lithium fluoride laser, or excimer (exciplex) laser cutting machine, e.g., the 5-axis computer numerical controlled laser cutting machine ML1515VZ20 that is manufactured by Mitsubishi Corporation. In another example, Sumitomo Heavy Industries, Ltd. makes laser cutting machines, such as the KrF excimer laser INDEX-848K having a wavelength of 248 nm.

The wavelength of the laser light may vary depending upon the type of material desired to be cut. In some embodiments, the wavelength is in the ultraviolet portion of the spectrum, i.e., from about 10 nm to about 400 nm. In other embodiments, a specific portion of the ultraviolet spectrum may be selected, such as from about 200 nm to about 300 nm. For example, for many polymers, 248 nm light may be effective for cutting. In other embodiments, other portions of the electromagnetic spectrum may be selected for the laser. Infrared light may also be selected, e.g., carbon dioxide lasers in the 9,400 nm-10,640 nm wavelength range may be desirable for certain metals. In other embodiments, lasers operating at 355 nm, 532 nm, and 1064 nm may be desirable for other metals. Similarly to the selection of wavelength, the power of the laser and/or the duration of any laser pulses or exposure to laser beams may be selected depending upon such factors as the wavelength, the power source, the type of material desired to be cut, and the type of cutting desired.

The type of laser cutting machine may be selected based on a variety of factors. For instance, the type of laser cutting machine may be selected based on the precision of the laser oscillator, the materials of the golf ball to be cut, the desired texture to be created by the laser, and/or the desired size and shape of the golf ball dimples. Laser cutting machine 100 may include a laser oscillator 104 configured to generate a laser. The laser oscillator 104 may include any suitable type of laser oscillator for cutting away golf ball cover material. The type of laser oscillator may be selected based on a variety of factors. For example, the type of laser oscillator may be selected based on the type of laser cutting machine used. The laser cutting machine 100 may include a power source configured to power laser oscillator 104. As shown in FIG. 1, the power source may include a transformer 108. The type of power source may be selected based on a variety of factors such as the type of laser oscillator being used as the laser oscillator 104.

The laser cutting machine 100 of FIG. 1 may include a laser head 102. The laser head 102 may be connected to the laser oscillator 104 and may be configured to focus the laser produced by the laser oscillator 104. Laser head 102 may include a laser nozzle 116 disposed on the bottom of the laser head 102. The laser nozzle 116 may be configured to further focus the laser and emit a laser beam, and may be adjustable to increase and/or decrease the focus of the laser beam. In some embodiments, the laser nozzle 116 may be adjusted by a user interface 106. The user interface 106 is discussed in more detail below. The type of laser head 102 and/or laser nozzle 116 may be selected based on a variety of factors. For example, the type of laser head and laser nozzle may be selected based on the type of the laser cutting machine used and/or the desired diameter, depth, and shape of the golf ball dimples.

A workpiece holder may include any suitable type of holder. For example, as shown in FIG. 1 the workpiece holder may include a workpiece table 110. The type of workpiece holder may be selected based on a variety of factors, e.g., the shape and size of workpiece to be laser cut and/or the type of laser cutting machine included in the system. As shown in the exemplary embodiment, the workpiece holder may be configured to hold an example golf ball 118. However, other embodiments of the laser cutting machine 100 may be used to laser cut workpieces other than golf balls. In such embodiments, the workpiece holder may be configured to hold other types of workpieces.

The workpiece table 110 may have a holding portion such as a spindle configured to hold the golf ball 118. In some embodiments, the workpiece table 110 may have one or more pins configured to hold the golf ball 118 by having the tips of the pins press against the golf ball 118 on opposing sides. In some embodiments, the workpiece table 110 may include an air-blowing system that levitates the golf ball 118 to maintain the golf ball 118 in a certain position. The workpiece table 110 may include a vacuum suction system that uses vacuum suction to maintain the golf ball 118 in a certain position.

As shown in the example embodiment of FIG. 1, the workpiece holding portion of workpiece table 110 may include a first clamp 120 and a second clamp 122. The first clamp 120 may include a cup shaped to contact the golf ball 118. The cup may be connected to a screw configured to be screwed through a plate 124. Plate 124 may have a threaded hole configured to receive the screw of the first clamp 120. The second clamp 122 may include a cup shaped to contact a golf ball. The cup may be connected to a screw configured to be screwed through a plate 126. Plate 126 may have a threaded hole configured to receive the screw of the second clamp 122. The cups of the respective first and second clamps 120, 122 may each have a shape corresponding to the shape of the golf ball 118. Accordingly, the golf ball 118 may fit flush against the cups. To secure a base or stock golf ball 118 to the workpiece table 110, the golf ball 118 may be placed between the first clamp 120 and the second clamp 122. The first clamp 120 may be twisted through the hole of plate 124 to move the cup closer to the golf ball 118. The second clamp 122 may be twisted through the hole of plate 126 to move the cup closer to the golf ball 118. The pressure applied to the golf ball 118 by the respective first and second clamps 120, 122 may be adjusted as needed to secure the golf ball 118 in place.

The laser cutting machine 100 of FIG. 1 may include a movement system providing motion between the laser head 102 and the workpiece, e.g., the ML1515VZ20 from Mitsubishi Corporation as noted above. According to the embodiment shown in FIGS. 1-5, the laser cutting machine 100 may include a 5-axis cutting machine configured to move the laser head 102 in three directions and the workpiece in two directions. In some embodiments, the laser cutting machine 100 may include a 5-axis cutting machine configured to move the laser head 102 in two directions and the workpiece in three directions. The laser cutting machine 100 may alternatively include a 6-axis cutting machine configured to move the laser head 102 in three directions and the workpiece in three directions. Providing multiple directions of movement between the laser head 102 and the workpiece holder may provide many cutting pattern possibilities.

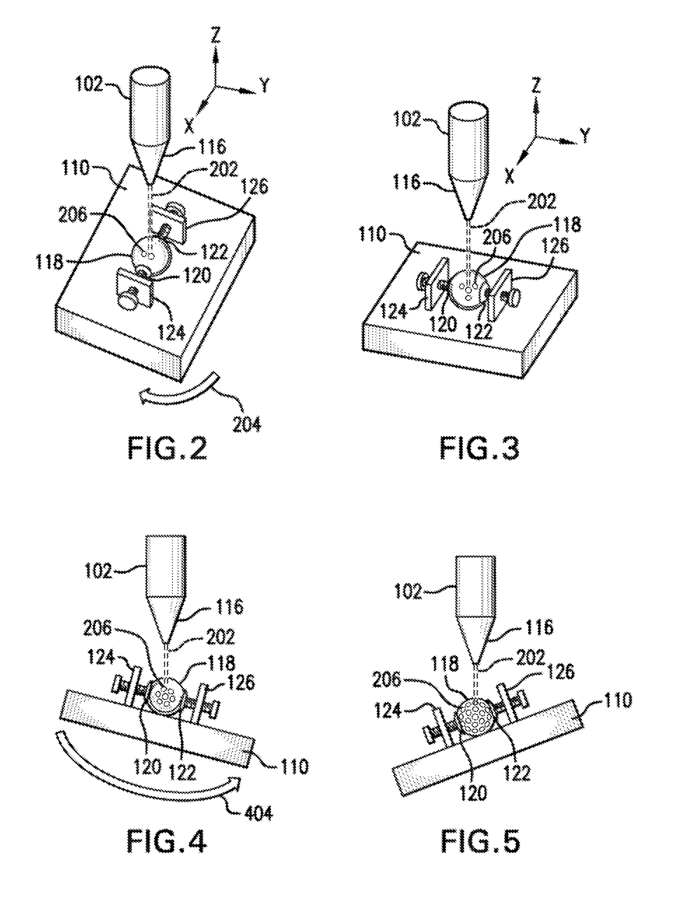

As shown in FIG. 1, the workpiece table 110 may be configured move a workpiece during laser cutting. FIGS. 2-5 demonstrate how the workpiece table 110 may be pivotable in two directions. FIG. 2 is a perspective view of the laser head 102 and the workpiece table 110 of FIG. 1 in a first position. FIG. 3 is a perspective view of the laser head 102 and the workpiece table 110 of FIG. 1 in a second position. As indicated by arrow 204 in FIG. 2, the workpiece table 110 may be pivoted about the z-axis. FIGS. 2 and 3 demonstrate how the workpiece table 110 may be pivoted from the first position shown in FIG. 2 in the direction indicated by arrow 204 to the second position shown in FIG. 3. Correspondingly, the workpiece table 110 may be pivoted in the opposite direction about the z-axis. FIG. 4 is a side view of the laser head 102 and the workpiece table 110 of FIG. 1 in a third position. FIG. 5 is a side view of the laser head 102 and workpiece table 110 of FIG. 1 in a fourth position. As indicated by arrow 404 in FIG. 4, the workpiece table 110 may be pivoted about the x-axis. FIGS. 4 and 5 demonstrate how the workpiece table 110 may be pivoted from the third position shown in FIG. 4 in the direction indicated by arrow 404 to the fourth position shown in FIG. 5. Correspondingly, the workpiece table 110 may be pivoted in the opposite direction about the x-axis. In some embodiments, the workpiece table 110 may be linearly moveable in place of or in addition to being pivotably moveable. For example, workpiece table may be linearly moveable in directions parallel to the x-axis, y-axis, and/or z-axis.

The laser head 102 of FIG. 1 may be linearly moveable in directions parallel to the x-axis, y-axis, and/or z-axis shown in FIGS. 2 and 3. For example, the laser head 102 may be moved along the z-axis toward and away from the workpiece table 110, The laser head 102 may be moved along the x-axis and y-axis to reposition the laser head 102 with respect to the workpiece held by workpiece table 110. In some embodiments, the laser head 102 may be pivotably moveable in place of or in addition to being linearly moveable.

FIGS. 2-5 demonstrate how the laser head 102 of FIG. 1 may emit a laser beam 202 that cuts dimples 206 in the golf ball 118. As discussed above, the laser head 102 and/or workpiece table 110 may be moved as the laser beam 202 removes material from the cover of the golf ball 118. Moving the laser head 102 and/or the workpiece table 110 may cause the laser beam 202 to remove material from the cover of the golf ball 118 in a pattern based on the relative movement between the laser head 102 and the workpiece table 110. The relative movement between the laser head 102 and the workpiece table 110 and the focus of the laser beam 202 may be configured to form various patterns on a golf ball. For example, in some embodiments, the relative movement between the laser head 102 and the workpiece table 110 and the focus of laser beam 202 may be set to form dimples in the cover of the golf ball 118.

The laser beam emitted from the laser head 102 may be adjusted to leave the surface of a golf ball smooth after cutting. Correspondingly, the laser beam emitted from the laser head 102 may be adjusted to leave marks in the wake of the laser beam. The marks resulting from laser cutting may be so subtle and uniform that the roughness of the surface of the golf ball may be extremely low. In some embodiments, the laser cutting machine 100 of FIG. 1 may be used to cut closely-spaced fine lines and/or other repeated patterns that add texture to the surface of the golf ball such that the surface of the golf ball is rougher.

As discussed above, the laser cutting machine 100 may include a computer numerical controller 112 configured to control the movement between the laser head 102 and the workpiece. For example, as mentioned above, Mitsubishi Corporation makes 5-axis computer numerical controlled laser cutting machines, such as the ML1515VZ20. In some embodiments, the computer numerical controller 112 may be configured to control the focus of the laser beam emitted from the laser head 102. The computer numerical controller 112 may include any suitable type of computer numerical controller. The type of computer numerical controller may be selected based on a variety of factors. For instance, the type of computer numerical controller may be selected based on the type of laser head and/or type of workpiece table used.

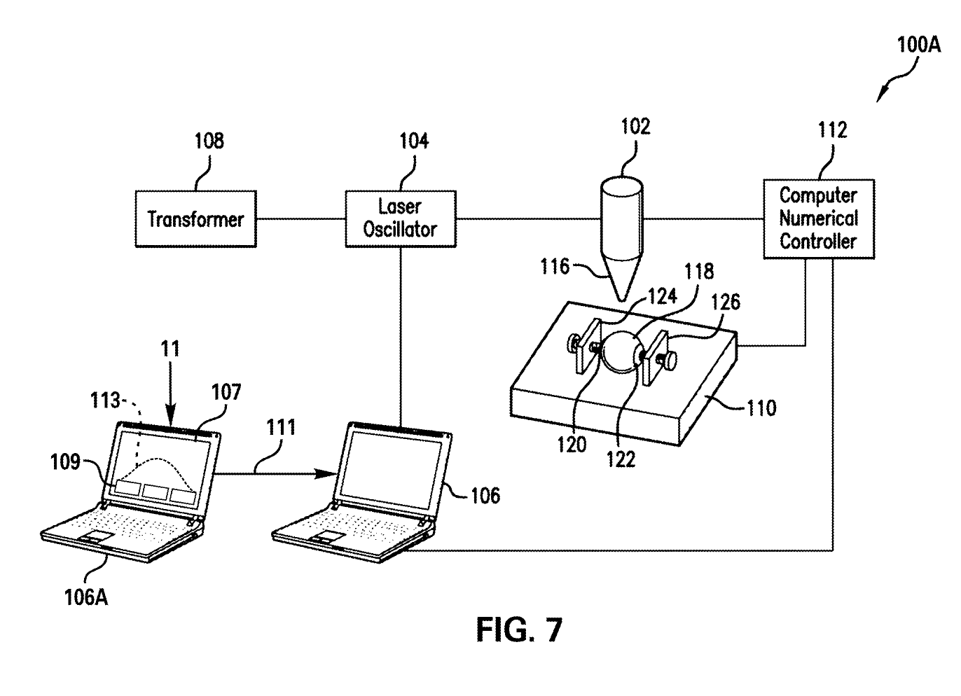

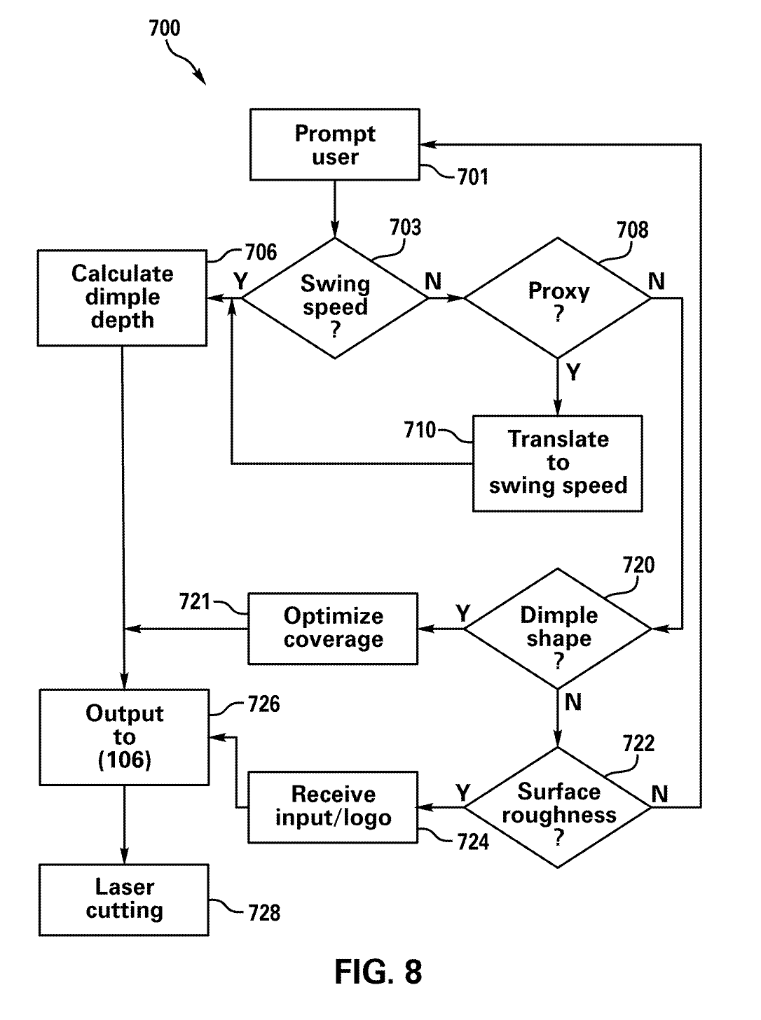

The laser cutting machine 100 of FIG. 1 may include a user interface 106. The user interface 106 may include any suitable type of user interface through which a user may control the laser head 102 and/or the computer numerical controller 112. For example, the user interface 106 may include a panel on one of the components of laser cutting machine 100 that is linked to a processor and a memory. In some embodiments, the user interface 106 may include a personal computer. The type of user interface used may be selected based on a variety of factors, such as the type of laser head 102 and/or the type of computer numerical controller 112 that is used. The user interface 106, which may have an optional additional user interface 106A as explained below with reference to FIGS. 7 and 8, may be configured to program the computer numerical controller 112, and may be configured to enable a user to control the laser produced by the laser oscillator 104 and/or the laser beam emitted from the laser head 102. The user interface 106 may include multiple user interfaces, e.g., the additional user interface 106A of FIGS. 7 and 8. Alternatively, a first user interface may be configured to enable a user to control the laser beam emitted from laser head 102 and a second user interface may be configured enable a user to control the computer numerical controller 112.

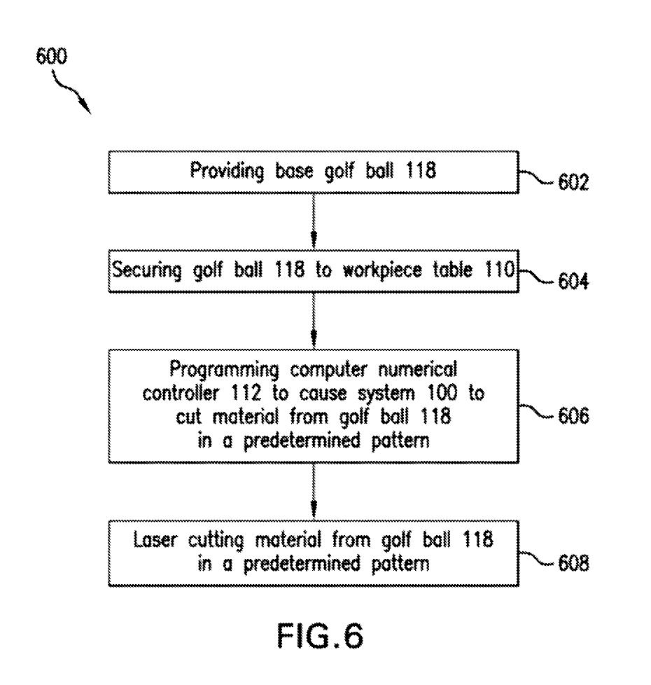

FIG. 6 includes an exemplary embodiment of a disclosed method 600. Method 600 may include steps 602, 604, 606, and 608. Step 602 may include providing the base or stock golf ball 118 to be laser cut. Step 604 may include securing the golf ball 118 to the workpiece table 110. Step 606 may include programming the computer numerical controller 112 to cause the laser cutting machine 100 to cut material from the cover of the golf ball 118 in a predetermined pattern. Step 608 may include laser cutting material from the cover of golf ball 118 in a predetermined pattern.

As discussed above, the base golf ball upon which dimples are to be formed or adjusted may include any type of golf ball. In some embodiments, the base golf ball may include a 1-piece, 2-piece, 3-piece, or 4-piece golf ball. In other embodiments, the base golf ball may include 5 or more layers. Step 602 may include providing base golf ball 118 to be laser cut. Providing a base golf ball 118 may include making base golf ball 118. Step 602 may include forming the layers of a golf ball by any suitable process. For example, in some embodiments, step 602 may include compression molding a core, placing the core in a hemispherical mold having smooth surfaces, and injection molding cover material around the core. In some embodiments, step 602 may include injection molding a core, placing the core in a hemispherical mold having smooth surfaces, and injection molding cover material around the core. In other embodiments, step 602 may include compression molding an inner core, compression molding an outer core surrounding the inner core, and injection molding cover material around the inner core. Step 602 may include molding an outer surface of the golf ball to include dimples. In some embodiments, step 602 may include molding an outer surface of the golf ball 118 to be smooth without dimples. The base golf ball 118 may have a larger diameter than the diameter of the finished golf ball. A larger diameter may allow for material to be removed through laser cutting during step 608 to arrive at the diameter of the finished golf ball.

As stated above, step 604 may include securing the golf ball 118 to the workpiece table 110. Step 604 may be achieved by placing the golf ball 118 between the respective first and second clamps 120, 122 of the workpiece table 110. The first clamp 120 and the second clamp 122 may be moved toward the golf ball 118 to secure the golf ball 118 by each clamping against the golf ball 118 on two opposing sides. To move toward the golf ball 118, the first clamp 120 may be twisted to move the screw within the first plate 124 and the second clamp 122 may be twisted to move the screw within the second plate 126. In other embodiments, the laser cutting machine 100 may include other types of workpiece holders configured to secure a golf ball. In such embodiments, step 604 may be carried out in a manner suitable to secure golf ball 118 to the workpiece holder. For example, the laser cutting machine 100 of FIG. 1 may include a spindle for holding a base golf ball 118 and step 604 may include securing the golf ball 118 within the spindle. In another embodiment, workpiece table 110 may have one or more pins configured to hold a golf ball 118 by having the tips of the pins press against the golf ball 118 on opposing sides. The workpiece table 110 may include an air-blowing system that levitates the ball to maintain the golf ball 118 in a certain position.

As stated above, step 606 may include programming the computer numerical controller 112 to cause or command the laser cutting machine 100 to laser cut material from the cover layer 119 of the golf ball 118 in a predetermined pattern. A user may use the user interface 106 to program the computer numerical controller 112 to move the workpiece table 110 and/or the laser head 102 in the predetermined path to laser cut material from the cover layer 119 of the golf ball 118 in a predetermined pattern. Step 606 may further include setting the laser head 102 to focus the laser beam 202 at a predetermined setting to achieve a certain texture or to cut a certain dimple shape. The predetermined setting may depend upon the predetermined pattern and/or the type of material to be cut away from the golf ball 118. A user may use the user interface 106 to set the laser head 102 to focus the laser beam 202 at the predetermined setting. In some embodiments, the user may use the user interface 106 to select a power level for the laser oscillator 104 at which to power the laser head 102. The power level may determine the focus of the laser beam 202 emitted by the laser head 102. Consequently, the focus of the laser beam 202 may correspond with the amount of cover material cut away by the laser beam 202.

Step 608 may include cutting material from the cover layer 119 of the golf ball 118 in a predetermined pattern. Laser cutting machine 100 may perform step 608. To perform step 608, the computer numerical controller 112 may cause the laser head 102 and/or the workpiece table 110 to move in a predetermined path while the laser head 102 emits a laser beam that cuts material from the outer surface of golf ball cover layer 119. The predetermined path may be selected to cause a certain relative movement between the laser head 102 and the workpiece table 110. Laser beam 202 may remove material from the cover layer 119 of the golf ball 118 in a pattern based on the relative movement between the laser head 102 and the workpiece table 110. The relative movement between the laser head 102 and the workpiece table 110 and the focus of laser beam 202 may be configured to form various patterns on the golf ball 118. For example, in some embodiments, the relative movement between the laser head 102 and the workpiece table 110 and the focus of the laser beam 202 may be set to form dimples in the cover layer 119 of the golf ball 118. In this case, the relative movement between the laser head 102 and the workpiece table 110 may cause the laser beam to move across the cover layer 119 of the golf ball 118 in the areas in which dimples are to be formed. FIGS. 2-6 demonstrate the laser beam 202 cutting dimples 206 on the golf ball 118 as the workpiece table 110 is moved in different positions. Step 608 may include adjusting the amount of material cut from areas of the golf ball 118 by decreasing or increasing the strength of the laser beam, or even turning off the laser beam, depending of the position of the laser head 102 relative to the golf ball 118.

As discussed above, in some embodiments, the laser cutting machine 100 may be used to cut closely-spaced fine lines and/or other repeated patterns that add a textured pattern to the surface of the golf ball such that the surface of the golf ball is rougher. In some embodiments, relative movement between the laser head 102 and workpiece table 110 and the focus of the laser beam 202 may be set to texturize the cover layer 119 of the golf ball 118. For example, the cover layer 119 of the golf ball 118 may be cut in a textured pattern including only the dimples, only the land area between dimples, or the entire surface of the golf ball. In the case that laser cutting machine 100 texturizes the entire golf ball 118, the relative movement between the laser head 102 and the workpiece table 110 may be set to keep the laser head 102 moving at a constant distance from the golf ball 118 to cut away material evenly from the entire surface of the golf ball 118.

The disclosed system and method may have many applications. For example, the disclosed system and method may be used during research and development to test different types of aerodynamic patterns. During testing of different types of aerodynamic patterns, the system and method may be used to add or modify dimples to a pre-made golf ball. During testing of different types of aerodynamic patterns, the system and method may be used to add or modify dimples to a testing golf ball. For example, testing golf balls may include those described in U.S. patent application Ser. No. 12/958,843, entitled Systems and Methods for Evaluating a Golf Ball Design, applied for by Fitchett and filed on Dec. 2, 2010, the disclosure of which is hereby incorporated by reference in its entirety.

In other applications, the system and method may be used during or after manufacture in order to produce a customized product. For instance, the system and method may be used to finish a base or stock golf ball 118 as shown in FIG. 1, i.e., a pre-finished golf ball having a standardized dimple shape and pattern or one lacking dimples, with a customized dimple pattern or other custom surface feature selected or otherwise determined by the customer or other user. In some applications, the system and method may be used by a retailer for ball fitting analysis, e.g., as disclosed in U.S. Patent Application Publication Number 2011/0009215, entitled Method and System for Golf Ball Fitting Analysis, applied for by Ichikawa and published on Jan. 13, 2011, the disclosure of which is hereby incorporated by reference in its entirety.

FIG. 7 depicts an example laser cutting machine 100A that is suitable for manufacturing use in order to produce a customized end product, in this instance a golf ball 118. As noted above, the user interface 106 shown schematically in FIG. 1 may include multiple user interfaces. An example of such an additional user interface 106A is shown in FIG. 7. The user interface 106A may be any computer device in networked communication with the user interface 106, e.g., via a dedicated network channel, the internet, or the like. As such, the user interface 106A may be embodied, by way of example, as any microprocessor-based computing device or devices having a processor and memory, including but not necessarily limited to magnetic or optical read only memory, random access memory, electrically-erasable programmable read-only memory, flash memory, etc., and any required input/output devices and other requisite circuitry as is known in the art.

The user interface 106A of FIG. 7 may be specially configured, i.e., programmed in software and equipped in hardware, to receive a set of user input criteria (arrow 11) and generate a customized feature request signal (arrow 111) using the received set of user input criteria. The customized feature request signal (arrow 111) generated by the user interface 106A corresponds to a custom surface feature of the golf ball 118, i.e., of at least an outer 10-30 μm coating of the cover layer 119 and possibly additional material of the cover layer 119. As noted above, the surface of the cover layer 119 of the golf ball 118 may include dimples having a predetermined depth and shape. Laser cutting of material from the cover layer 119 changes at least one of the predetermined depth and shape of the dimples in some embodiments. Logic necessary for generating the customized feature request signal (arrow 111) may reside in the user interface 106A, or in an alternative embodiment, the user interface 106A may simply receive and relay the set of user input criteria (arrow 11) to the user interface 106.

In the embodiment shown in FIG. 7, a user may access the user interface 106A via a display screen 107 or other human-machine interface device and respond to a set of user prompts 109. For instance, the display screen 107 may be a touch screen and the user prompts 109 may be one or more icons and/or text-based prompts requesting entry of a desired surface feature, such as a customized depth and/or shape of the dimples on the cover layer 119. Alternatively, the user prompts 109 may request entry of a desired logo on the outer cover of the golf ball 118, with the term “logo” as used herein referring to any image, letters, characters, or the like which would effectively form a custom watermark on the cover layer 119, with any such a watermark retaining the disclosed performance customization via the effect, e.g., of changing the dimple depth or other surface feature.

With respect to golf ball dimples in general, it is known in the art that the presence of dimples on the surface of any golf ball directly affects the aerodynamics of the golf ball while in flight. This occurs via creation of turbulence in the boundary layer around the golf ball, thus reducing drag and increasing lift. The depth, shape, and pattern of dimples on a golf ball thus helps to produce a particular shot trajectory, which in turn is shaped by swing speed, spin, and other factors such as the moisture level or dew point of the air. Additionally, dry or firm ground is generally advantageous for flatter shot trajectories in terms of overall drive distance, as a golf ball tends to roll considerably farther on such a surface relative to wet or soft turf. Dimples, which tend to range in number from about 300 to about 500 per golf ball, are ideally distributed evenly across the surface of a golf ball. The laser cutting machine 100A of FIG. 9 thus enables a user to customize the dimples to a particular set of user criteria, doing so via the user prompts 109, while still maintaining optimal coverage of the surface.

In general, a 10 μm change in dimple depth corresponds to approximately 2 yards in height for a tour-speed drive, or about 1 yard for a tour-speed 6-iron shot. While conventional off-the-shelf golf balls are produced in volume with an “optimal” dimple depth, this depth is largely determined using an average swing speed and average environmental conditions. It is recognized herein that the true optimal depth for a given golfer will vary based on the golfer's swing speed and the actual environmental conditions in which that golfer is expected to play. By way of example, wet ground will not provide much if any roll, while the opposite holds true for dry ground. Likewise, a golfer with a faster or slower relative swing speed may desire a steeper or flatter trajectory relative to that provided via a stock golf ball. The user interface 106A thus allows a user to enter information about the user and/or the user's environment, with this information thereafter used in control of the laser cutting process as described above.

In an example embodiment, the display screen 107 may be embodied as an interactive display. The user prompts 109 may be in the form of a series of questions with multiple choice answers, e.g., “swing speed=tour level, above average, below average/novice, or slow/beginner”, with a slower swing speed generally corresponding to shallower dimples, or questions could be displayed to evaluate the spin characteristics of the user's typical shot. That is, if a ball has too much spin, dimples providing a lower trajectory are desirable, while insufficient spin benefits from a high-trajectory dimple.

Alternatively, the user interface 106A may be in communication with a launch monitor of the type known in the art, i.e., a sensor or array of sensors configured to measure swing speed, spin, and/or other swing parameters. The user prompts 109 in this instance may cue the user to swing a golf club in proximity to the launch monitor, with the measured parameters such as swing speed and spin then imported into the user interface 106A as part of the set of user input criteria (arrow 11). As a given user's swing speed may not be known, alternative user prompts 109 can serve as a proxy for swing speed, for instance the user's age, height, or average drive length. Generally speaking, as a person ages their relative swing speed tends to decrease. Likewise, a taller golfer tends to have a faster swing speed, while a longer average drive length tends to be the result of a faster swing speed.

Additionally, the user prompts 109 may request the user to confirm the type of ground on which the golf balls 118 are to be played, e.g., wet/soft, semi-dry, or dry/hard surfaces, and/or a general geographic location or environmental conditions corresponding to such levels, e.g., dry/clear, rainy/wet, etc. Upon receiving a response to the user prompts 109, the user interface 106A may optionally generate and display a trace of an ideal shot trajectory 113 via the display screen 107. The user can then confirm the order for custom golf balls if the displayed ideal shot trajectory 113 is satisfactory to the user, with the user interface 106 thereafter proceeding in the control of the laser cutting process as set forth above with reference to FIGS. 1-6.

In another embodiment, the user prompts 109 may ask the user to enter a desired geometric shape for the dimples as the custom surface feature in lieu of or in conjunction with the customized depth. For instance, the user may be presented, again via the display screen 107, with an available set of geometric shapes, e.g., stars, rectangles, polygons, and the like. Such dimple shapes provide yet another way in which a user may customize the golf ball 118 to their unique preferences. As the selected geometric shape affects the possible coverage or distribution of the dimples on the cover layer 119, the user interface 106A or 106 of FIG. 7 may be programmed with mathematical optimization logic of the type known in the art that ensures maximum symmetrical distribution on and coverage of the cover layer 119 with the selected geometric shape. That is, the golf ball 118 when it is finished must have uniform flight characteristics regardless of how the golf ball 118 is oriented on a tee. As non-symmetrical dimple patterns will tend to cause non-symmetrical flight characteristics, symmetry of the distribution pattern is required when customizing dimple shape, and is thus ensured via the optimization function.

In yet another embodiment, the user prompts 109 may request entry of a custom micro-surface roughness to be formed across a pre-formed dimple pattern in the golf ball 118. In this manner, a user may be able to order customized golf balls having a unique logo or performance-optimizing watermark etched into the coating of the cover layer 119. By way of a non-limiting example application, a user may wish to etch a set of initials into the outer coating or additional material of the cover layer 119, with the initials visible in the contrast between adjacent smooth and roughened surface areas of the cover layer 119. In such an embodiment, the user prompts 109 may optionally request uploading of an image file depicting a desired logo, selection of one or more characters from a predetermined listing of acceptable characters for the logo, or the like.

In all of the above-described embodiments, the laser cutting machine 100A of FIG. 7 may reside at a retail establishment or at a regional distribution facility. The user interface 106A may be a networked web-based or application-based device collocated with or located remotely with respect to the other components of the laser cutting machine 100A. For instance, a kiosk may be provided at a point of sale offering stock golf balls 118 to also allow a user to order a customized version of the golf balls 118, or to customize the golf balls 118 post-sale, with a custom surface feature of the type described above. The same customized access to the functionality of the laser cutting machine 100A may be provided via an application on a user's smart phone, a tablet computer, or other app-enabled device, or over the internet or other network connection via entry of a suitable web address into a browser. The laser cutting machine 100A thereafter laser cuts material from the cover layer 119 of the golf ball 118 in response to the customized feature request signal (arrow 111) to thereby form the custom surface feature on the cover layer 119.

An example method 700 is provided for use with the laser cutting machine 100A described above. The method 700, an example of which is shown in FIG. 8, allows for the forming of a custom surface feature on the stock golf ball 118, and includes, after providing the golf ball 118, the step of receiving the set of user input criteria (arrow 11) via the user interface 106A. The method 700 also includes generating the customized feature request signal (arrow 111) using the received set of user input criteria (arrow 11), with the customized feature request signal (arrow 111) corresponding to a custom surface feature of the cover layer 119. In response to receipt of the customized feature request signal (arrow 111), the user interface 106 commands the laser cutting of material from the cover layer 119 using the laser head 102 of laser cutting machine 100A. Formation of multiple custom surface features is made possible in the non-limiting example embodiment described below. However, those of ordinary skill in the art will appreciate that simpler variations of the method 700 may be envisioned which contemplate formation of only one or fewer than all of the possible custom surface features, e.g., dimple depth.

Referring to FIG. 8, in an example embodiment the method 700 includes step 701, wherein the user interface 106A displays the user prompts 109 via the display screen 107 to thereby prompt a user, i.e., a potential buyer or user of the golf ball 118, to input the set of user input criteria (arrow 11) as shown in FIG. 7. Various types of set of user input criteria (arrow 11) are possible, and therefore the user interface 106A may be programmed to consider any or all of these options depending on the level of customization a provider wishes to offer.

The set of user input criteria (arrow 11) received at step 701 in response to the user prompts 109 may include a measured actual or imported swing speed from a launch monitor or a selected swing speed of the user as noted above, or proxy information such as the user's age, height, average drive length, average middle iron distance, e.g., average 6-iron distance, etc. While FIG. 8 is directed to swing speed in particular, one may use spin or other relevant characteristics without departing from the intended inventive scope. Other user prompts 109 requesting the user input criteria (arrow 11) may include a desired geometric shape of any dimples to be formed on the cover layer 119 and/or whether a custom logo is desired. The method 700 proceeds to step 703 once the corresponding user prompts 109 have been displayed.

At step 703, the user interface 106A next determines if the user recorded or otherwise entered or provided a swing speed at step 701, whether measured or relative. If so, the method 700 proceeds to step 706. The method 700 proceeds in the alternative to step 708 if a swing speed was not entered.

Step 706 includes determining a dimple depth using the swing speed entered at step 701. Step 706 may include comparing the swing speed to a plurality of pre-recorded swing speeds or bands of swing speeds each corresponding to a different range of predetermined dimple depths and then selecting the corresponding range of dimple depths. Once determined, the dimple depth is recorded in memory. The method 700 thereafter proceeds to step 726.

Step 708 is reached when it is determined that a user has not entered a swing speed at step 701. When this occurs, the user interface 106A determines if an alternative set of criteria has been entered that may act as a suitable proxy for such a swing speed. For instance, the user interface 106A may determine if the user's age, height, or average drive/shot distance has been entered at step 701, any of which may serve as a proxy for swing speed. The method 700 proceeds to step 710 if such proxy criteria have been entered. Otherwise, the method 200 proceeds to step 720.

At step 710, the user interface 106A translates the proxy criteria into a corresponding swing speed, e.g., via access to a pre-recorded lookup table, via a formula, or the like. The method 700 then proceeds to step 706.

At step 720, having determined at step 708 that proxy data for a user's swing speed has not been entered, the user interface 106A may use the dimple depth of the golf ball 118 and proceed to evaluate if any other custom surface features are required. For instance, one of the user prompts 109 at step 701 if selected may request a custom dimple shape as opposed to a custom dimple depth. If this option is selected, the method 700 proceeds to step 721. The method 700 otherwise proceeds to step 722.

Step 721 entails optimizing the coverage of the selected dimple shape from step 701, e.g., via execution of a mathematical optimization function or logic to ensure symmetrical coverage of the cover layer 119. The method 700 thereafter proceeds to step 726.

Step 722 is reached if a user has not entered a swing speed, criteria suitable as a proxy for swing speed, or a desired dimple shape at step 701, as determined as steps 703, 708, and 720, respectively. At step 722 the user interface 106A determines whether the user has requested, in response to the user prompts 109, that the golf ball 118 be modified with a custom surface feature in the form of a micro-surface texture or roughness. As noted above, such texture may be etched into the surface of the cover layer 119 of the golf ball 118 to provide a water mark or other indicia or logo. The method 700 proceeds to step 724 if a user has requested such micro-surface texture. The method 700 repeats step 701 in the alternative, i.e., if the user has not responded to any of the user prompts 109 displayed at the first iteration of method 700.

Step 724 may entail receiving an input file or logo via the user interface 106A. Such an input file or logo describes the pattern, appearance, or other parameters of the surface roughness to be applied to the golf ball 118. Step 724 may include scanning in or otherwise uploading a logo, e.g., an image, picture, diagram, letters, characters, or the like. Step 724 may also include selecting a predetermined logo from a pre-recorded set of such logos. Such an embodiment may ensure that the types of logos are appropriate for manufacture, e.g., are capable of being formed on the surface of the golf ball 118 by the laser cutting machine 100. The method 700 proceeds to step 726 once the input file or logo is received.

At step 726, the user interface 106A generates the customized feature request signal (arrow 111 of FIG. 7) using the received set of user input criteria of step 701, and then outputs the customized feature request signal to the user interface 106. The customized feature request signal corresponds to a custom surface feature of the cover layer 119 of golf ball 118. The user interface 106 is thereby informed as to the level of customization that is required of the golf ball 118. The user interface 106 can then proceed as described above with reference to FIGS. 1-6, i.e., by communicating with the computer numerical controller 112 and the laser oscillator 104 as needed to control the laser head 102 in its described operation.

The method 700 concludes with step 728 with the laser cutting of material from the cover layer 119 of the golf ball 118 by the laser cutting machine 100A in response to the customized feature request signal (arrow 111). The laser cutting machine 100A thus forms the custom surface feature on the cover layer 119 of the golf ball 118. The result of method 700 is a modified version of the stock golf ball 118, with the customized feature request corresponding to the custom surface feature originally requested at step 701.

Using the method 700 as set forth hereinabove or modified as desired, e.g., to contemplate spin versus swing speed as noted above, the option of customizing golf ball dimples and/or other surface features of the golf ball 118 may be extended to a user via a web-based or application-based customer interface. In this manner, the customer could provide certain inputs that affect the dimple pattern of the balls they purchased. Benefits of using this manufacturing ability include producing a single stock ball at the manufacturing facility (one base SKU) that can be customized just prior to or after the point of sale. Laser cutting may be performed, for example, at retail establishments or at regional distribution facilities as a value-added service.

While the best modes for carrying out the disclosure have been described in detail, those familiar with the art to which this disclosure relates will recognize various alternative designs and embodiments within the scope of the appended claims. It is intended that all matter contained in the above description or shown in the accompanying drawings shall be interpreted as illustrative only and not as limiting. Moreover, the referenced figures are not necessarily drawn to scale, and relative sizes should neither be inferred nor implied.

Additionally, the term “a,” “an,” “the,” “at least one,” and “one or more” are used interchangeably to indicate that at least one of the items is present. A plurality of such items may be present unless the context clearly indicates otherwise. All numerical values of parameters, e.g., of quantities or conditions, in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. In this description of the invention, for convenience, “polymer” and “resin” are used interchangeably to encompass resins, oligomers, and polymers. The terms “comprises,” “comprising,” “including,” and “having,” are inclusive and therefore specify the presence of stated items, but do not preclude the presence of other items. As used in this specification, the term “or” includes any and all combinations of one or more of the listed items. In other words, “or” means “and/or.” When the terms first, second, third, etc. are used to differentiate various items from each other, these designations are merely for convenience and do not limit the items.

1. A method comprising:
providing a golf ball having a core and a cover layer surrounding the core;
receiving a set of user input criteria via a user interface;
generating a customized feature request signal using the received set of user input criteria, wherein the customized feature request corresponds to a custom surface feature of the cover layer; and
laser cutting material from a surface of the cover layer using a laser head of a laser cutting machine in response to the customized feature request signal to thereby form the custom surface feature on the cover layer.

2. The method of claim 1, wherein the golf ball includes dimples having a predetermined depth and shape, and wherein laser cutting material from the surface of the cover layer includes modifying at least one of the predetermined depth and shape.

3. The method of claim 2, wherein receiving the set of user input criteria includes determining a spin level imparted to a golf ball by a user, and wherein laser cutting material from the cover layer includes changing the depth of the dimples based on the determined spin level.

4. The method of claim 2, wherein receiving the set of user input criteria includes determining a swing speed of a user, and wherein laser cutting material from the cover layer includes changing the depth of the dimples based on the swing speed of the user.

5. The method of claim 4, wherein receiving the set of user input criteria includes receiving an average shot length of the user, the method further comprising determining the swing speed using the average shot length.

6. The method of claim 2, wherein receiving a set of user input criteria includes receiving a geometric shape, and wherein changing the shape of the dimples includes laser cutting the received geometric shape into the cover layer.

7. The method of claim 6, further comprising using an optimization function to optimize coverage of a pattern of the geometric shape across a surface of the cover layer.

8. The method of claim 1, wherein the set of user input criteria includes a logo, and wherein laser cutting material from the cover layer includes forming a textured pattern on a surface of the cover layer to thereby form the logo on the cover layer.

9. The method of claim 1, further comprising displaying, via a display screen of the user interface, an ideal shot trajectory corresponding to the set of user input criteria.

10. A system comprising:
a laser head operable for laser cutting material from a surface of a cover layer of a golf ball;
a computer numerical controller in communication with the laser head, and programmed to control a laser beam generated by the laser head; and
a user interface in communication with the computer numerical controller, wherein the user interface is programmed to:
receive a set of user input criteria;
generate a customized feature request signal using the received set of user input criteria, wherein the customized feature request corresponds to a custom surface feature of the cover layer; and
request, via transmission of the customized feature request signal to the computer numerical controller, the laser cutting of material from the surface of the cover layer via the laser head to thereby form a custom surface feature on the cover layer of the golf ball.

11. The system of claim 10, wherein the golf ball includes dimples having a predetermined depth and shape, and wherein the user interface is programmed to request laser cutting of the material from the surface of the cover layer by modifying at least one of the predetermined depth and shape.

12. The system of claim 10, wherein the set of user input criteria includes a swing speed of a user, and wherein the user interface is programmed to request laser cutting of the material by changing the depth of the dimples based on the swing speed of the user.

13. The system of claim 10, wherein the set of user input criteria includes a spin level imparted to a golf ball by the user, and wherein laser cutting material from the cover layer includes changing the depth of the dimples based on the determined spin level.

14. The system of claim 10, wherein receiving a set of user input criteria includes receiving a geometric shape, and wherein the user interface is programmed to request laser cutting of the material by laser cutting the received geometric shape into the cover layer.

15. The system of claim 14, wherein the computer numerical controller or the user interface is programmed to execute an optimization function to thereby optimize coverage of a pattern of the geometric shape across a surface of the cover layer.

16. The system of claim 10, wherein the set of user input criteria includes a logo, and wherein the user interface is programmed to request laser cutting of the material by forming a textured pattern on a surface of the cover layer to thereby form the logo on the cover layer.

17. The system of claim 10, wherein the user interface is operable for displaying, via a display screen, an ideal shot trajectory corresponding to the set of user input criteria.
